(19) United States
(12) Patent Application Publication
(10) Pub. No.: US 2007/0260812 A1
(43) Pub. Date: Nov. 8, 2007

(54) Programming method for write buffer and double word flash programming

(75) Inventors: Greg Amidon, Schaumburg, IL (US); Samil Asim Addemir, Naperville, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Westell Technologies, Inc., Aurora, IL (US)

(21) Appl. No.: 11/453,631

(22) Filed: Jun. 15, 2006

Related U.S. Application Data
(60) Provisional application No. 60/797,716, filed on May 4, 2006.

(51) Int. Cl. G06F 12/00

(52) U.S. Cl. 711/103

(57) ABSTRACT

A method and system for implementing buffer programming of flash devices during in-circuit testing is described. Some flash device can implement buffer programming, but the ICT is not capable of supporting this application. By creating a file for buffer programming of flash devices that has the same number of bits in each line and counting the number of lines in the file having data, flash devices can be programmed using buffer programming with the ICT. Additionally, by adjusting the line count to an even multiple of the length of an executable code stored in the flash device, program loops may be used.

### PRIORITY

The present patent application claims priority under 35 U.S.C. § 119(e) to U.S. Provisional Patent Application Ser. No. 60/797,716, which was filed May 4, 2006. The full disclosure of U.S. Provisional Patent Application Ser. No. 60/797,716 is incorporated herein by reference.

### RELATED APPLICATIONS

This application is related to the following concurrently filed U.S. Applications, which are incorporated by reference herein:
U.S. patent application Ser. No. ______; filed on Jun. 15, 2006, entitled “Flash Programmer for Programming NAND Flash and NOR/NAND Combined Flash,” to Amidon et al.; and
U.S. patent application Ser. No. ______; filed on Jun. 15, 2006, entitled “Parallel Programming of Flash Memory During In-Circuit Test,” to Amidon et. al.

### FIELD

The present invention relates generally to programmable devices, and more particularly, relates to write buffer and double word programming of flash devices during in-circuit testing.

### BACKGROUND

Manufacturers of high volume products have several options for programming programmable devices in a product. One option is to program the devices prior to assembling and soldering the devices to a printed circuit board (PCB). Another option is to program the devices after they are soldered to the PCB.

On board programming is generally more flexible due to the nature of programming the parts later in the manufacturing process. Less potential rework exists when the customization of the product occurs later in the process. Sending out programmable devices for programming can cause a two to ten day delay. This delay creates a need for up to ten days of pre-programmed devices on-hand. When a programming change occurs, all of the pre-programmed devices on-hand and in the pipeline require re-programming. Programming the devices on board reduces this two to ten day supply down to zero, reducing the need for re-programming to just the PCBs that are already produced, which would be required in either scenario.

There are several options for programming devices on board. A common method is to utilize an In-Circuit Tester (ICT) to download the code to the device. In a high volume-manufacturing environment, the time of download plus the actual ICT test time must be within the time requirements of the manufacturing process or a bottleneck in the process may form at ICT. Improvements to the flash programming speed may eliminate this bottleneck. Programming done within the required timeframe at the ICT is nearly free, while programming out of house or on separate platforms can be expensive. If the programming is done using the ICT, when in-circuit testing is already performed, the cost may be close to zero. The speed of programming is critical to obtaining this near zero cost.

ICTs typically use a vector processor for testing and programming. However, several programming options for flash devices do not work with vector-based systems. For example, the write buffer mode available with the Spansion LLC MirrorBit™ flash family does not work with vector-based systems. Essentially, the vector-based systems are good at “fixed” programming algorithms, but are unable to handle programming methods in which decisions are made on the fly, such as the write buffer mode.

Therefore, a method for buffer programming flash devices during in-circuit testing would be beneficial. As a result, flash devices may be programmed quickly, resulting in near-free programming costs during ICT testing.

### SUMMARY

A method and system for programming flash devices during in-circuit testing is described. A method includes reading executable code stored in the flash device, inserting the executable code into an array, wherein each line of the executable code is inserted in a respective line in the array, and wherein each line in the array has a same number of bits, counting a number of lines in the array that have data, and providing as an output the array and the number of lines in the array having data. The method may also include adjusting the line count to a multiple of a number of lines used in a looping program, changing an endian format, using an address offset value to start at a first flash address, using the array and the line count for programming the flash device more than one word at a time, using the array and the line count for write buffer programming the flash device, and/or using the array and the line count for double word programming of the flash device.

Another method for programming a flash device during in-circuit testing includes reading executable code stored in the flash device, inserting the executable code into an array, counting a number of lines in the array that have data, identifying a sector address location to initiate programming, and programming the flash device with the array starting at the identified sector address location and ending based on the line count. Each line of the executable code is inserted in a respective line in the array, and wherein each line in the array has a same number of bits

A system for programming a flash device during in-circuit testing includes a processor, data storage, and machine language instructions stored in the data storage executable by the processor to read executable code stored in the flash device, insert the executable code into an array, wherein each line of the executable code is inserted in a respective line in the array, and wherein each line in the array has a same number of bits, count a number of lines in the array that have data, and use the array and the line count for programming the flash device more than one word at a time.

The system may also include machine language instructions stored in the data storage executable by the processor to adjust the line count to a multiple of a number of lines used in a looping program, to change an endian format, and to use an address offset value to start at a first flash address.

The executable code may be an S-Record file, an Intel Hex file, a binary file, a code image file, or any other appropriate file format. Each line in the array may have thirty-two bytes, sixteen bytes, or 4 bytes. The flash device may be programmed using write buffer programming or double word programming.

These as well as other aspects and advantages will become apparent to those of ordinary skill in the art by reading the following detailed description, with reference where appropriate to the accompanying drawings. Further, it is understood that this summary is merely an example and is not intended to limit the scope of the invention as claimed.

### BRIEF DESCRIPTION OF THE DRAWINGS

Presently preferred embodiments are described below in conjunction with the appended drawing figures, wherein like reference numerals refer to like elements in the various figures, and wherein:

FIG. 1 is a block diagram of an in-circuit tester, according to an example;

FIG. 2 is a block diagram of a circuit board panel, according to an example;

FIG. 3 is a flow diagram of a byte alignment program; according to an example;

FIG. 4 is a screen shot of an example user interface for initializing the program depicted in FIG. 3; and

FIG. 5 is a flow diagram of a write buffer program that uses the output of the alignment program depicted in FIG. 3, according to an example.

### DETAILED DESCRIPTION

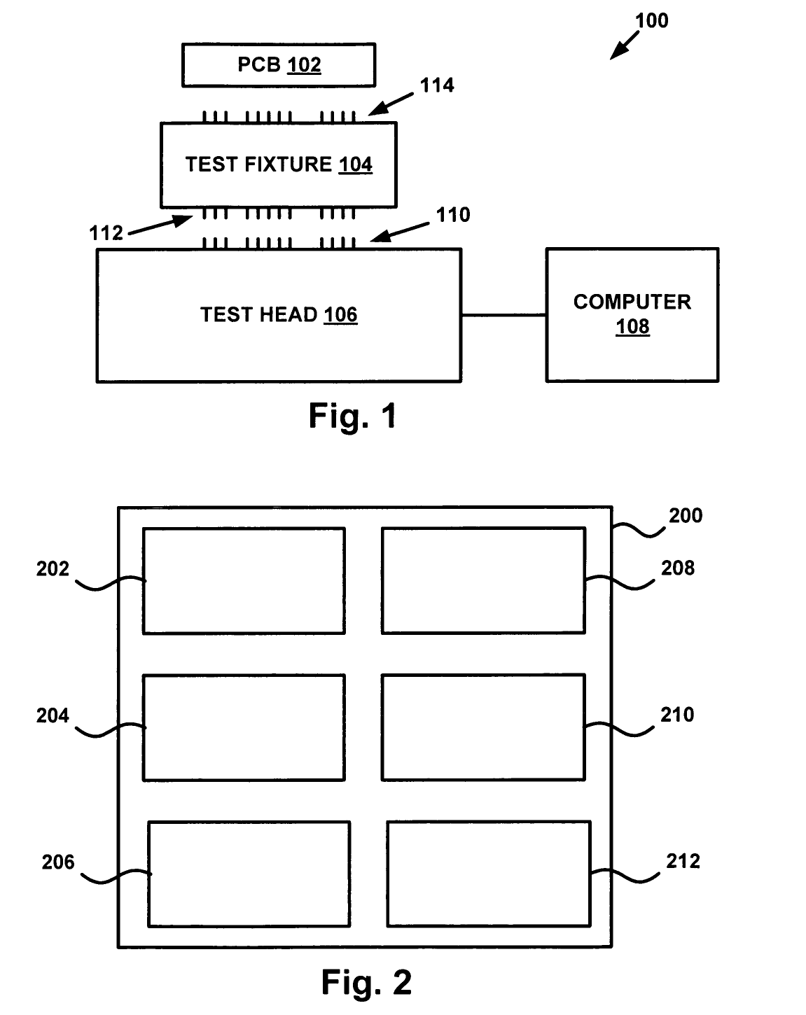

FIG. 1 is a block diagram of an In-Circuit Tester (ICT) 100. As a non-limiting example, the ICT 100 may be an HP/Agilent 3070. Typically, the ICT 100 includes a test fixture 104, a test head 106, and a computer 108. The ICT 100 may be designed to test a printed circuit board (PCB) 102 or a circuit board panel that includes more than one PCB, such as the circuit board panel 200 described with reference to FIG. 2. For example, the ICT 100 may test the PCB 102 or the circuit board panel 200 for shorts, opens, current draw, tolerances, and/or functionality. The test fixture 104 may be customized for each PCB design.

The computer 108 includes a processor, data storage, and machine language instructions stored in the data storage executable by the processor as is well known in the art. The computer 108 is not limited to having any particular type of processor, data storage, or instruction format. The computer 108 may select a test application dedicated to a particular type of circuit board design. Generally, the test application drives information to the test head 106 and receives information in response.

The test head 106 receives the information from the computer 108 and responds by driving a number of test pins 110 on the test head 106, including those test pins 110 that provide data and address information to the test fixture 104. The test fixture 104 includes contacts 112 aligned with at least some of the test pins 110, which are routed to corresponding spring probes 114. The spring probes 114 are positioned in such a manner so that when the PCB 102 or the circuit board panel 200 is placed on the test fixture 104, the spring probes 114 establish contact with various test pads (not shown) located at a bottom surface of the PCB 102 or the circuit board panel 200. These test pads are routed to various pins of the components attached to the PCB 102 or the circuit board panel 200.

The processor in the computer 108 may be a vector processor, which facilitates testing the PCB 102 or the circuit board panel 200. The vector processor generates an input that is sent to the PCB 102 or the circuit board panel 200, and in response, the vector processor expects a particular output from the PCB 102 or the circuit board panel 200. If the vector processor receives the expected output, then that particular test pattern may be considered as a passing test. Otherwise, the vector processor may identify a test failure, which may indicate that there is a problem with the PCB 102 or the circuit board panel 200. While the vector processor provides efficient testing of the PCB 102 or the circuit board panel 200, this type of processor is unable to make a decision.

The ICT 100 may also be used to program memory components on the PCB 102 or the circuit board panel 200. For example, the ICT 100 may be used to program flash devices located on the PCB 102 or the circuit board panel 200. Generally, the ICT 100 sends programming commands to the flash device, applies the address and data to be programmed, and then polls to verify completion of the programming. Typically, each flash device type has specific instructions for programming that is provided to the ICT 100.

FIG. 2 is a block diagram of the circuit board panel 200. The circuit board panel 200 may include more than one PCB, such as PCBs 202-212. While the circuit board panel 200 is shown with six PCBs 202-212, the circuit board panel 200 may have more or less than six PCBs. The PCBs 202-212 are generally multiple instances of the same circuit manufactured as a panel of circuit boards for manufacturing efficiency. The PCBs 202-212 may be separated by cutting or breaking after manufacture and test, to provide separate products. For example, each of the PCBs 202-212 may be a modem board.

Some flash devices are designed to be programmed using vendor specific programs designed to program more than one word at a time. For example, Spansion LLC provides a MirrorBit™ flash family that includes write buffer programming. Spansion's write buffer programming allows the programming system to write to a maximum of 16 words/32 bytes in one programming operation. To use this write buffer programming, the 32 bytes must be contiguous and not cross sector boundaries. Using write buffer programming allows the flash device to be programmed faster than when using word-programming. According to Spansion's documentation, word-programming takes approximately four times as long as the write buffer mode.

As another example, STMicroelectronics provides a double word or quad byte programming mode. Note that two words and four bytes are the same, and both are referred to as double word mode herein. The double word mode requires four continuous bytes for programming. However, with a standard Motorola S-Record or Intel HEX file, words that are 0xFF at the end of a line or complete lines of 0xFF are stripped from the file, which may leave an odd number of bytes per line.

Unfortunately, the ICT 100 cannot program flash devices using the write buffer mode or the double word mode due to the inability of the vector processor to make decisions. For example, the ICT 100 cannot search forward in a file and determine which addresses can use the double word mode and which addresses cannot. Thus, it would be beneficial to provide a solution that allows the ICT 100 to use write buffer mode and/or the double write mode to program flash devices on the PCB 102 or the circuit board panel 200.

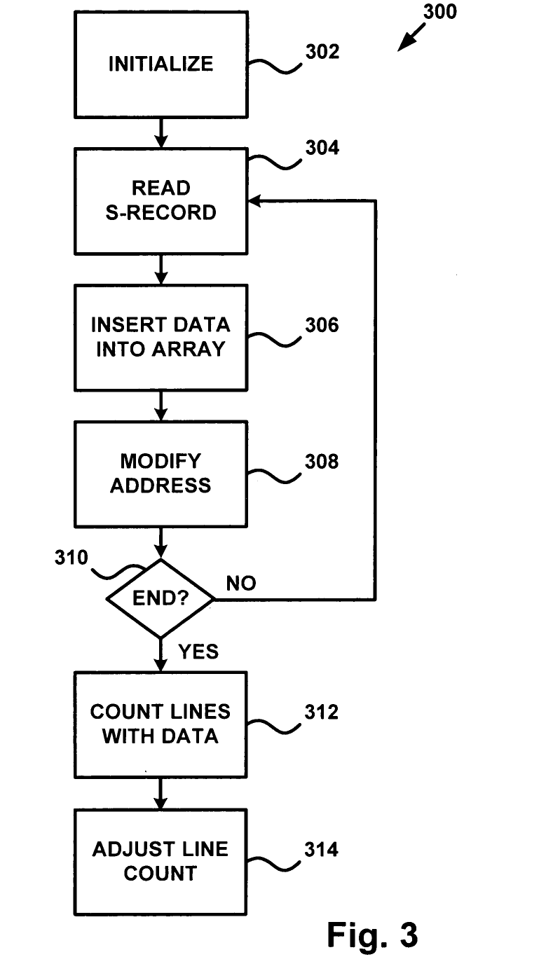

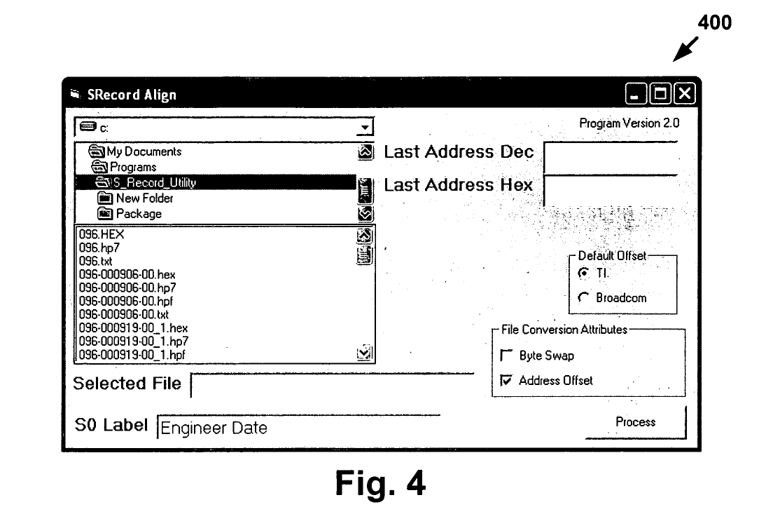

By overcoming the limitations of the vector processor, the ICT 100 can be used to program flash devices in write buffer and double word modes. For the write buffer mode, this may be accomplished by implementing a flash byte alignment program, followed by a write buffer program as described with reference to FIGS. 3-5. Similarly, for the double word mode, this may be accomplished by implementing the flash byte alignment program, followed by a double word program. Using the write buffer program example, those skilled in the art could implement a double word programming algorithm for the ICT 100 using vendor supplied specifications once the byte alignment is performed.

FIG. 3 is a flow diagram of a byte alignment program 300. The byte alignment program 300 is a software routine that maintains flash programming on contiguous bytes. In addition to aligning data, the byte alignment program 300 also ensures that sector boundaries are not breached. The byte alignment program 300 may also be used to ensure that a specific multiple of lines are utilized so that looping programs can end on an even number. By aligning all bytes on a 32, 16, or 4 byte alignment, sector alignment can be maintained when starting at byte 0. Preferably, the 32 byte alignment is used to increase programming speed.

The byte alignment program 300 is described using the non-limiting example of a Motorola formatted S-Record file, which is executable code stored in some flash devices. The total number of lines in the final Motorola S-Record file is evenly divisible by 2048 to allow program loop multiples that are evenly divisible. The format of the Motorola S-Record file is AABBCCCDDDDEE, where:

AA (1 byte): The record type starts with an S followed by a single digit. The record type defines what format and type of data is to follow. The standard types are: start record, data record, and end record. The byte alignment program 500 uses the following record types:

S0=Start record.

S1=Data Record (4 character address, 2 bytes).

S2=Data Record (6 character address, 3 bytes).

S3=Data Record (8 character address, 4 bytes).

S7=End Record

S8=End Record

S9=End Record

BB (1 byte): Record length is the byte count of the record for that line. The byte count is the total number of bytes used by the address, data, and checksum fields. Each byte of data is depicted as two characters.

CCC (2, 3, or 4 bytes depending on record type): The address location the data that follows belongs to. The first piece of data is located at the address listed in AAAAH.

DDDD (0 to n bytes): This is the data that is location at the address listed.

EE (1 byte): The checksum. The checksum is created by taking the one's complement of the sum of all the bytes in the length address and data fields. The Record type bytes are not part of the checksum calculation.

While the current example uses a Motorola formatted S-Record file as the input and output, it is understood that other file formats may be used, such as Intel Hex, binary, and code image files.

At block 302, the byte alignment program 300 is initialized. A user interface may be used to assist in the selection of options. FIG. 4 depicts a screen shot 400 of an example user interface. The user interface allows a user to locate and select the S-Record file of interest. The selected S-Record file appears in the “Selected File” text box.

The S-Record file is processed based on the selected File Conversion Attributes. The File Conversion Attributes depicted in FIG. 4 are Byte Swap and Address Offset. Other File Conversion Attributes are possible. As seen in FIG. 4, the Address Offset check box is selected in this example. If the endian format requires changing, the user can select the Byte Swap check box, which changes the endian from “little endian” to “big endian” or from “big endian” to “little endian”. The Address Offset check box allows a default offset to be utilized.

The default offset check box allows for selection of either TI or Broadcom file offset. Other default offset selections are also possible. The offset is used when an initial value address location is not located at address 0. This may occur when a product requires the beginning flash address to be shifted in memory. The offset values for the two options depicted in FIG. 4 are: TI=0xB0000000 and BROADCOM=0xBFC00000. The offsets are subtracted from the S-Record file addresses to start the addressing at address 0x00 (i.e., the first flash address).

The “S0 Label” box allows the user to insert a comment at the top of the S-Record file as the ICT 100 typically ignores the S0 line. The user interface may allow the user to provide additional information to initialize the byte alignment program 300. Alternatively, the byte alignment program 300 may be designed so that the byte alignment program 500 is automatically initialized, without any user input.

Initialization typically occurs with an array of 0xFFs created for the file size of the flash. This is essentially a blank flash from address 0x00 to the end. When the user clicks the “Process” button on the user interface or the byte alignment program 300 is otherwise started, the byte alignment program 300 verifies that the file settings and configuration options are valid, and then begins processing the selected S-Record file.

Returning to FIG. 3, at block 304, the S-Record file is read from the flash device line by line. At block 306, the data read at block 304 is inserted or otherwise written into the array, overwriting the 0xFFs. At block 308, the address is modified by subtracting the address offset selected on the user interface depicted in the screen shot 400. If byte swap is selected, the bytes are inserted by swapping the high and low byte. The entire S-Record file is processed per blocks 304-308 until the end of file, which is determined at block 310. The byte alignment program 300 now has a complete image of the flash device in the array. Each line in the array has the same number of bits, e.g., thirty-two bytes (or 256 bits) in this example.

At block 312, the byte alignment program 300 counts the number of lines in the array that have data. Any line that is still contains 0xFF is ignored. These ignored lines may be created during the initialization of the array and, subsequently, are not overwritten by the S-Record file that was read and written into the array.

In the process of counting the number of lines containing data, each line that has data is initially considered as the last address. The array starts at the base address of 0x00 and continues up from there until the last address. So as the byte alignment program 500 finds a line containing data, the address of that line is larger than the previous line. In this manner, the highest address with valid data is known.

At block 314, the number of lines counted as having data is adjusted to the next even multiple of 2048 and that adjusted number becomes the number of lines included as an output of the byte alignment program 300. As described above, the total number of lines in the final Motorola S-Record file is evenly divisible by 2048 to allow program loop multiples that are evenly divisible. However, the number of lines counted may be adjusted to any other number as appropriate for loop alignment so as to provide the ICT 100 with a consistent number from which to work.

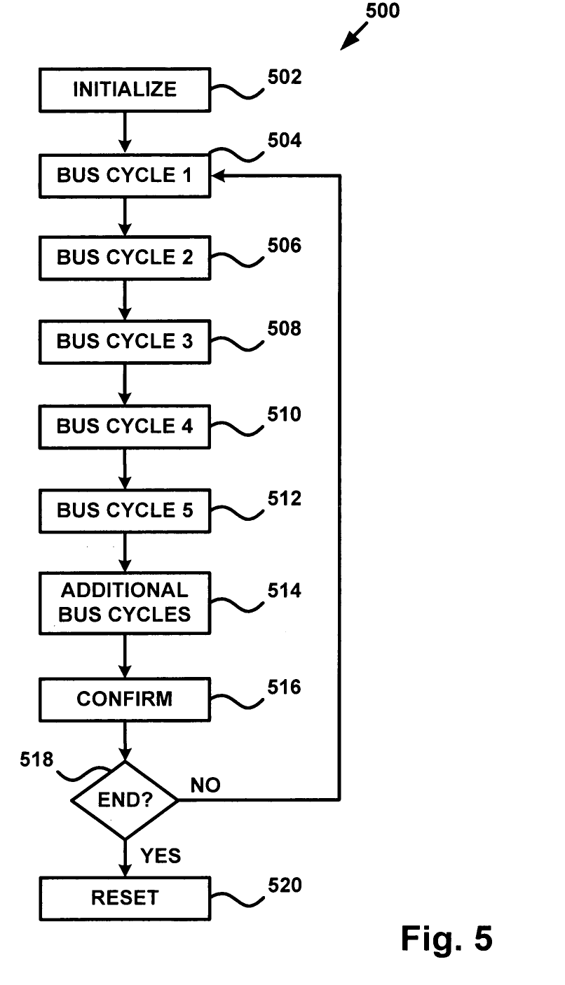

The byte alignment program 300 outputs each line with data, as well as the number of lines needed to end on an even multiple of 2048. The byte alignment program 300 may store its output in a file with an appropriate extension to identify the file type, such as a file ending with the .hpf extension. The output file may be stored in memory in the computer 108. The stored file may then be used by a write buffer program 500 described with respect to FIG. 5 or other vendor write program.

The byte alignment program 300 may also be used to align to a number of bytes different than 32. For example, the byte alignment program 300 may be used to provide a continuous four byte alignment as needed for STMicroelectronics double word mode programming. Because words that are 0xFF at the end of a line or complete lines of 0xFF may be stripped from a standard Motorola S-Record or Intel HEX file resulting in an odd number of bytes per line, the byte alignment program 300 is needed to perform double word mode using the ICT 100. The byte alignment program 300 reintroduces the missing 0xFF bytes where needed to ensure a contiguous four byte alignment.

FIG. 5 is a flow diagram of the write buffer program 500 that uses the output of the byte alignment program 300. The write buffer is a set of registers used to hold several words that are to be programmed as a group. The buffer is filled with words to be programmed before issuing the write buffer programming command. The time to program each word is reduced by performing programming overhead operations once for the entire group of words. This results in a faster effective word/byte programming time than the standard word/byte programming algorithms.

The write buffer program 500 is described as follows using the Write Buffer Command Set as provided by Spansion LLC, but it is understood that other flash device commands sets may be used. In Table 1, SA is sector address, WC is word count, PA is program address, PD is program data, and WBL is write buffer location. The total number of cycles in the command sequence is determined by the number of bytes written to the write buffer. The maximum number of cycles in the command sequence is 37, including the “Program Buffer to Flash” command. Additional information can be found in the Spansion LLC documentation.

TABLE 1

| | | Bus Cycles | | | | | | | | | | | |
|---|---|---|---|---|---|---|---|---|---|---|---|---|---|
| | | First | | Second | | Third | | Fourth | | Fifth | | Sixth | |
| Command Sequence | Interface | Addr | Data | Addr | Data | Addr | Data | Addr | Data | Addr | Data | Addr | Data |
| Write to Buffer | Word | 555 | AA | 2AA | 55 | SA | 25 | SA | WC | PA | PD | WBL | PD |
| | Byte | AAA | | 555 | | | | | | | | (Note) | |
| Program Buffer to Flash | Both | SA | 29 | | | | | | | | | | |
| (Confirm) | | | | | | | | | | | | | |
| Write-to-BufferAbort | Word | 555 | AA | 2AA | 55 | XXX | F0 | | | | | | |
| Reset | Byte | AAA | | 555 | | | | | | | | | |

At block 502, initialization occurs. Initialization may include disabling other devices that may attempt to write or otherwise access the flash devices during programming. Additionally, control lines may be set to the appropriate values (e.g., a logic-0 or a logic-1) to initiate write buffer programming. A write-enable pulse may complete the initialization process and may also occur after each bus cycle described with reference to blocks 504-514. The data in the array obtained during the byte alignment program 300 may be used during the bus cycles 504-514.

At blocks 504 and 506, the write buffer programming command sequence is initiated by writing two unlock cycles. During the first bus cycle, the data on the address bus is equal to 555H, while the data the data bus is equal to AAH. During the second bus cycle, the data on the address bus is equal to 2AAH, while the data on the data bus is equal to 55H.

At block 508, a third bus cycle writes the Write Buffer Load command (i.e., data on the data bus is equal to 25H) at the Sector Address (SA) in which programming occurs. At block 510, a fourth bus cycle writes the SA and the word count (WC) to be programmed. At block 512, the fifth bus cycle writes the first address location and data to be programmed from the array. The write-buffer-page is selected by address bits A_{MAX}-A₄. All subsequent address/data pairs must fall within the selected-write-buffer-page.

At block 514, additional bus cycles write the remaining address/data pairs into the write buffer. After the address/data pairs are written, at block 516 the “Program Buffer to Flash” confirmation command sequence is performed with the data on the address bus equal to the SA and the data the data bus is equal to 29H. After another write-enable pulse, a delay may be necessary.

The write buffer program 500 then determines whether all the lines in the S-Record have been programmed at block 518 based on the adjusted count of lines having data in the array. If not, the program 500 loops back to block 504 to repeat the process at the first bus cycle. Otherwise, at block 520 the “Write-to-Buffer-Abort Reset” command sequence is performed to reset the flash device for the next operation.

An example write buffer program segment is also provided as follows:

```
segment 2048
    repeat 63488 times
  !***** 1_BusCycle  555 / AA
    execute Unlock_Cycle_1_Cmd
    execute Write
    execute End_Cycle
  !***** 2_BusCycle  2AA / 55
    execute Unlock_Cycle_2_Cmd
    execute Write
    execute End_Cycle
  !***** 3_BusCycle  SA / 25 (Sector Address)
    execute Data_W  drive data Address drive data Data
    execute Data_W_25
    execute Write
    execute End_Cycle
  !***** 4_BusCycle  SA / WC (sector address/word count)
    execute Data_W_F
    execute Write
    execute End_Cycle
      repeat 16 times
        execute Data_W  drive data Address drive data Data
        execute Write
        execute End_Cycle
        next Address
        next Data
      end repeat
    execute Data_W_BufferConfirm
    execute Write
    execute End_Cycle
    wait 4u
    execute Three_state wait
    end repeat
  end segment
  call Reset_Device
end unit
```

While an example program segment has been provided for the write buffer program 500, it is understood that there are a variety of different ways to program a function, and the write buffer program is not limited to any particular software code or structure. Moreover, instead of using the write buffer program 500, another vendor supplied specification may be used in conjunction with the byte alignment program 300.

The byte alignment program 300 and the write buffer program 500 (or other vendor write program) may be performed by the computer 108. By using these programs, the ICT may be able to implement vendor specific programs designed to program more than one word at a time. As a result, flash devices may be programmed quickly, resulting in near-free programming costs during ICT testing.

It should be understood that the illustrated embodiments are examples only and should not be taken as limiting the scope of the present invention. For example, while the invention has been described herein with reference to Spansion flash devices, the invention can be implemented with other flash devices, such as the flash devices manufactured by Sharp, Samsung, ST, Atmel, and Intel. The claims should not be read as limited to the described order or elements unless stated to that effect. Therefore, all embodiments that come within the scope and spirit of the following claims and equivalents thereto are claimed as the invention.

We claim:

1. A method for programming a flash device during in-circuit testing, comprising in combination:
reading executable code stored in the flash device;
inserting the executable code into an array, wherein each line of the executable code is inserted in a respective line in the array, and wherein each line in the array has a same number of bits;
counting a number of lines in the array that have data; and
providing as an output the array and the number of lines in the array having data.

2. The method of claim 1, further comprising adjusting the line count to a multiple of a number of lines used in a looping program.

3. The method of claim 1, further comprising changing an endian format.

4. The method of claim 1, further comprising using an address offset value to start at a first flash address.

5. The method of claim 1, further comprising using the array and the line count for programming the flash device more than one word at a time.

6. The method of claim 1, further comprising using the array and the line count for write buffer programming the flash device.

7. The method of claim 1, further comprising using the array and the line count for double word programming of the flash device.

8. A method for programming a flash device during in-circuit testing, comprising in combination:
reading executable code stored in the flash device;
inserting the executable code into an array, wherein each line of the executable code is inserted in a respective line in the array, and wherein each line in the array has a same number of bits;
counting a number of lines in the array that have data;
identifying a sector address location to initiate programming; and
programming the flash device with the array starting at the identified sector address location and ending based on the line count.

9. A system for programming a flash device during in-circuit testing, comprising in combination:
a processor;
data storage; and
machine language instructions stored in the data storage executable by the processor to:
read executable code stored in the flash device;
insert the executable code into an array, wherein each line of the executable code is inserted in a respective line in the array, and wherein each line in the array has a same number of bits;
count a number of lines in the array that have data; and
use the array and the line count for programming the flash device more than one word at a time.

10. The system of claim 9, further comprising machine language instructions stored in the data storage executable by the processor to adjust the line count to a multiple of a number of lines used in a looping program.

11. The system of claim 9, further comprising machine language instructions stored in the data storage executable by the processor to change an endian format.

12. The system of claim 9, further comprising machine language instructions stored in the data storage executable by the processor to use an address offset value to start at a first flash address.

13. The system of claim 9, wherein the executable code is a file having a format selected from the group consisting of S-Record, Intel Hex, binary, and code image.

14. The system of claim 9, wherein each line in the array has the same number of bytes selected from the group consisting of thirty-two bytes, sixteen bytes, and 4 bytes.

15. The method of claim 9, wherein programming the flash device includes write buffer programming the flash device.

16. The method of claim 9, wherein programming the flash device includes double word programming of the flash device.
